(19) United States
(12) Patent Application Publication
(10) Pub. No.: US 2010/0214877 A1
(43) Pub. Date: Aug. 26, 2010

(54) Event Reminding System

(76) Inventor: Ryan Christopher Turk, Peachtree City, GA (US)

Correspondence Address: Ryan C. Turk, 213 Woodruff Way, Peachtree City, GA, 30269, US

(21) Appl. No.: 12/709,498

(22) Filed: Feb. 21, 2010

Related U.S. Application Data
(60) Provisional application No. 61/155,480, filed on Feb. 25, 2009.

(51) Int. Cl. B65D 83/04; G04B 47/00

(52) U.S. Cl. 368/10; 206/534

(57) ABSTRACT

In a method for reminding a patient to take a medication, the medication is labeled with a predefined symbol. A device displays the predefined symbol each time the medication is to be taken by the patient.

### CROSS-REFERENCE TO RELATED APPLICATIONS

This application claims the benefits of U.S. Provisional Application No. 61/155,480, filed 25 Feb. 2009.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to systems for reminding individuals of upcoming events and, more specifically, to a system for reminding individuals who otherwise cannot tell time of upcoming events.

2. Description of the Prior Art

As of 2007, there are 33 million people infected with HIV/AIDS worldwide, of which over 70% live in third world countries. An individual infected with HIV has on average several years before HIV matures into the AIDS virus. Regardless of the stage of their infection, patients' lives could be dramatically improved and lengthened through treatment with the most effective antiviral drugs available. However, in developing countries alone, there are 9.7 million patients in immediate need of treatment to stay alive, of which only 3 million receive medicine. Effective antiviral drug treatment of HIV/AIDS is complicated. Drugs are not effective unless taken in strict adherence to a time schedule. Furthermore, like antibiotics, taking drugs partially or out of sequence results in a building resistance by the HIV/AIDS virus; hindering treatment of the patient and, if spread, strengthening the HIV/AIDS epidemic. In a hypothetical treatment regime, a patient may take daily up to four different antiviral pills in addition to pain-killers, vitamins, and medicine for the treatment of Hepatitis; prevalent in those infected with HIV/AIDS.

Providing these effective treatments to individuals in third world countries is a complex and multi-variable problem. However, whether pharmaceuticals are donated or purchased by relief organizations for patients, there remain barriers for getting treatment to those that need it. Among these issues is the one I am trying to solve: illiteracy and more importantly the inability to tell time. The majority of those infected with HIV/AIDS in third world countries cannot or do not have the means to tell time and therefore do not have the ability to take HIV/AIDS medication correctly or effectively. For instance, in the sub-Saharan country of Chad, of the 105,000 women infected with HIV/AIDS, up to 84,000 have no means of correctly taking complex medical treatments because of illiteracy. Two statistics make this problem so compelling: there are at least 22 million people in third world countries with HIV/AIDS, and nearly every third world country has a literacy rate less than 60 percent. Statistically, that means at least 10 million people are unable to realistically be treated effectively for HIV/AIDS because they cannot tell time

The inventor first learned of this issue when speaking to Ugandan relief workers recently returned from providing services to impoverished farmers in Africa. To their surprise, doctors informed them that drugs could be made available but that not enough patients lived within range of their clinic to make daily journeys for medicine practical. The underlining issue was the simple fact that there existed no system for them to take their medication accurately, consistently, and independently.

Therefore, there is a need for a system that assists individuals who cannot tell time from a conventional watch in recognizing the occurrence of an event, such as a notification that it is time to take a medication.

### BRIEF SUMMARY OF THE INVENTION

Symbols are displayed on a device—such as a watch, beeper, or any other display device, substituting a time display, eliminating the need for a person to tell time, track time, and otherwise use time as a means to reference, alert, remind, and otherwise signal a patient to take medication.

Corresponding symbols are used to label medications, eliminating the need for a person to read medication containers.

When a symbol on the display device is illuminated based on a programmed time interval, the patient matches the displayed symbol with the symbol previously labeled on the medication to be taken.

### BRIEF DESCRIPTION OF THE FIGURES OF THE DRAWINGS

FIGS. 1A-1B are exploded views of a watch according to one embodiment of the invention.

FIG. 2 is a schematic view of a representative configuration of a watch and corresponding pill packages

FIG. 3 is a schematic view of several display configurations.

FIG. 4 is a schematic view of programming instructions.

FIG. 5 is a schematic view of several symbols that could be used with the display device.

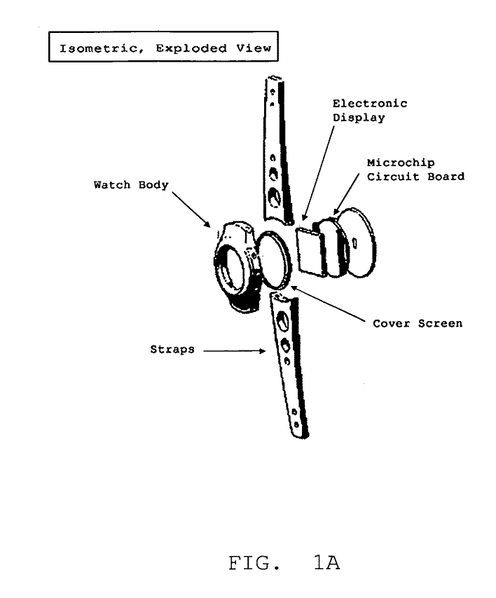

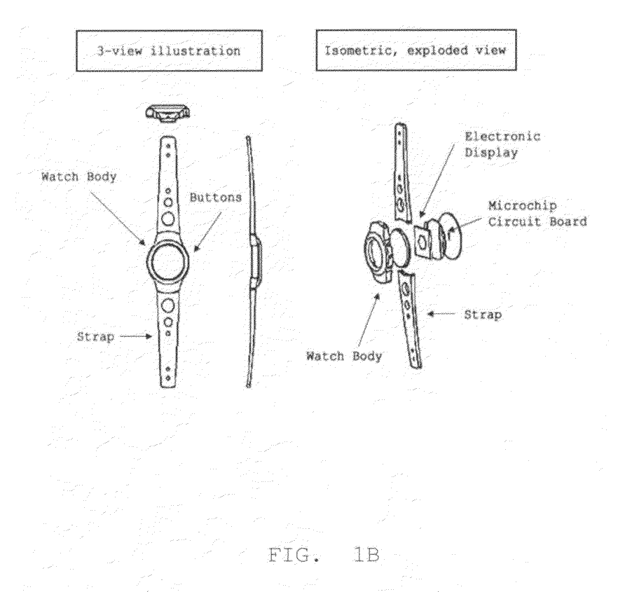

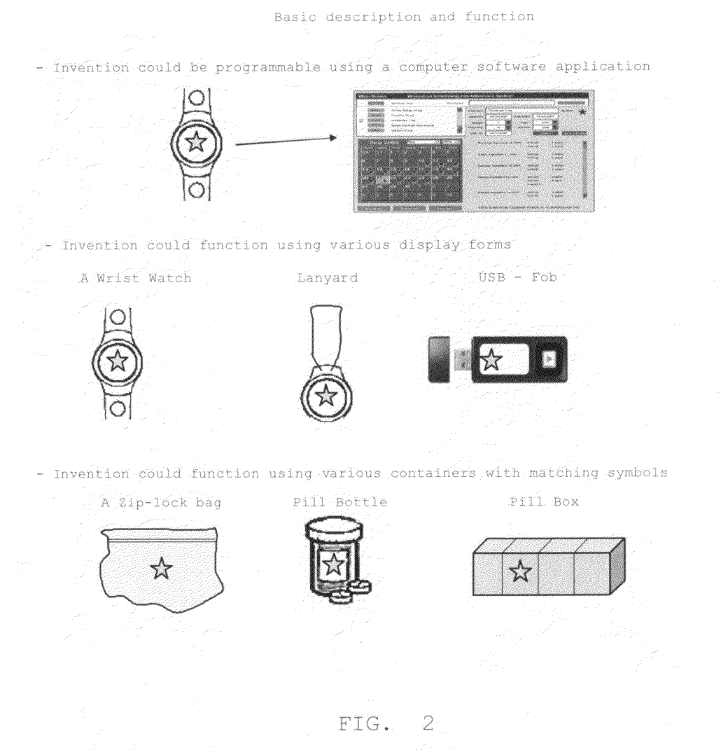

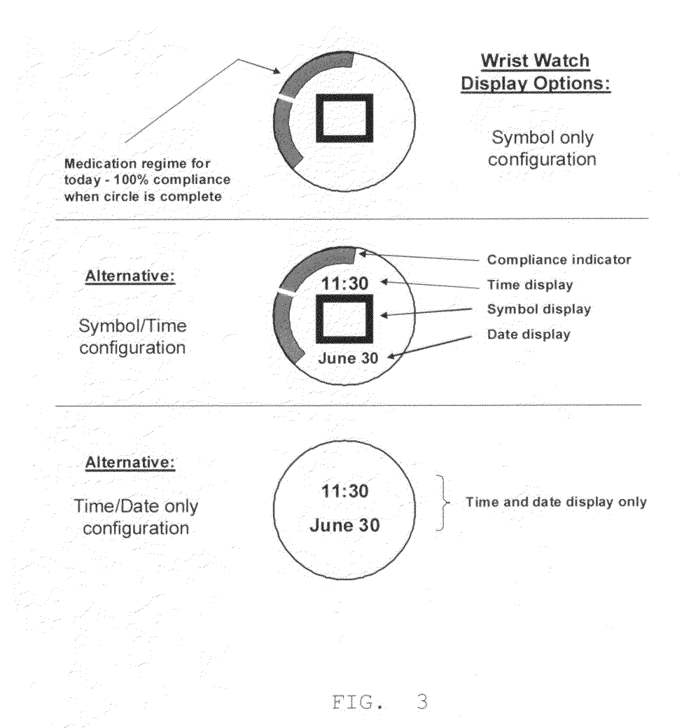

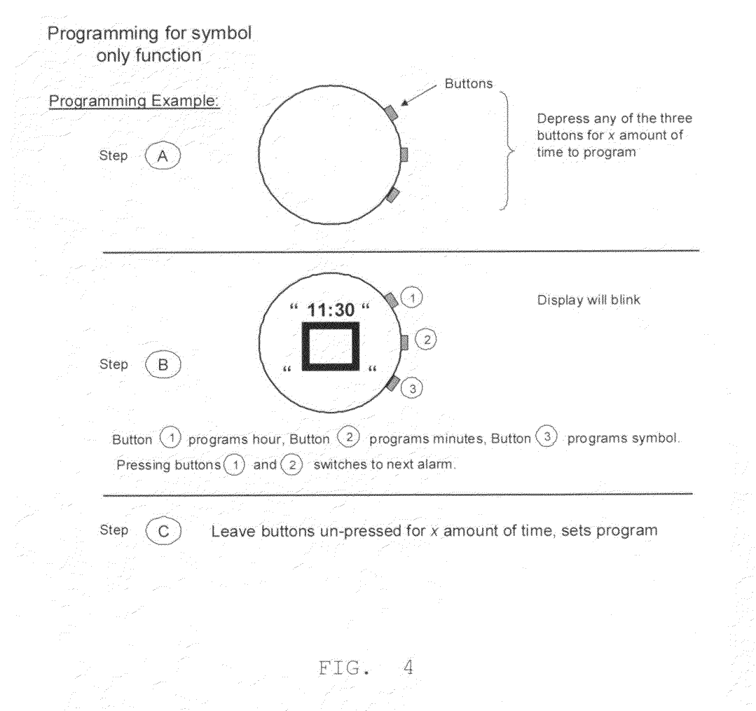

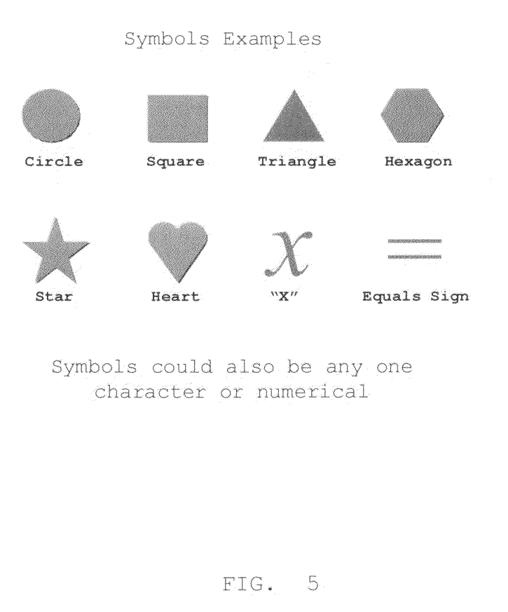

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

One embodiment of the invention, referred to herein as the “Time-for-Life watch,” is a medicine dosage reminder kit for patients that are illiterate or cannot tell time, that includes two components: 1.) a programmable electronic reminder device (watch) and 2.) packages for storing medication in the form of pills. The electronic reminder device is pre-programmed with alarms that activate at medication dosage times. When activated, the device emits an auditory alarm of monotone beeps and vibrates while displaying one of several symbols stored within its memory. Using symbols as a way to match dosage times with the proper medication, the patient matches the symbol displayed on the device screen to the corresponding medication package labeled with that same symbol.

The auditory alarm persists for 3-5 seconds when it is deactivated and the vibratory alarm persists until the patient deactivates it upon consuming the required medication.

When the patient has taken said medication, they may depress two of the three user input buttons on the device's side. Firstly, this disables the alarms. Secondly, a display circle segment, divided into as many segments as there are dosages in a day, is illuminated when the patient has indicated a dose has been consumed. (see scanned illustration of compliance indicator). If the patient has complied 100% successfully with his/her daily medication regime they may know so when the segmented circle indicator is complete.

The device can be configured in several ways including: as a wristwatch with straps, as a module worn on a lanyard around the neck, as a module stored in the pocket as a fob. The configuration by which it is used by the patient is unimportant in its functionality. However, the internal components of device do not change in relation to its configuration. The device, configured as a wristwatch, is shown with its constitute parts in the attached illustrations.

Furthermore, the device can be configured to perform several different function configurations. First, it can be configured to display only symbols at alarm times and the compliance indicator. Secondly, it can be configured to display the symbols and compliance indicator at alarm times, and display time and date throughout the day. Third, it can be used simply as a time and date watch utilizing alarms as used in normal electronic watch operation. Different display configurations are shown in the attached illustrations.

The pill packages can be any device suitable for safely containing medication in the form of pills. Preferable plastic, the package is labeled with an adhesive-backed label printed with any one of several symbols stored within the watch memory.

The device includes an electronic display controlled via a microchip circuit board with buttons for user input. The device is battery powered or powered via solar power. The device case is constructed of either plastic or metal and is sufficiently waterproof and shockproof.

Programming the Watch:

Programming begins when the user depresses all three buttons for a required amount of time. The display flashes and the user understands that programming may begin. Button one, located at the right of the display first button from top to bottom, adjusts the hour. Button two, located below button one, adjusts the minute. Button three, below button two, adjusts the desired symbol at the alarm time. The buttons are released, the three buttons are pressed simultaneously and programming begins for the next alarm. The process continues for however many alarms are desired. Upon finishing the programming, the user simply stops depressing buttons and after a required amount of time the watch switches to operation mode. This is shown in the attached illustrations.

When programming the watch when configured to display time only, the adjustment of the symbol is replaced with the adjustment of the day.

Symbols:

Although not exhaustive or all-inclusive, the attached illustration of symbols shows the nature of symbols stored in the watch memory, displayed at dosage times on the device screen, and labeled on the medication packages.

The Time-for-Life watch is a simple digital watch that displays symbols, coordinated with labeled packages of pills, so that HIV/AIDS patients can take complex medication. Using a universal language of symbols, patients regardless of age, education, or nationality, can take complex medication on time. For example, throughout the day the TFL watch will display a symbol at the appropriate time and the patient will take the medicine contained in the package with the appropriate symbol on the label. Patients are notified that it's time to take medicine by both an auditory and vibratory alarm. Using digital technology, TL watches can be programmed in a matter of minutes for an infinite variety of treatments and patients. Pill packages need not be more than zip-lock bags with printed labels. The technology utilized in the watch is not new; it exists in nearly any common and inexpensive digital watch on the market today. The development necessary for the Time-for-Life watch includes only the re-configuring of already existing digital watch hardware.

The watch and symbol system is the invention, but Time-for-Life is as much an idea as it is an invention. The system by which the Time-for-Life watch is developed, marketed, distributed, and sustained is the biggest challenge and its most complicated component.

The primary cost in developing and putting into action the use of Time-for-Life watches worldwide has two components: development and distribution. The developmental costs are comparatively low knowing that all technology used exists; thereby drawing on the advantage not of creating new technology but of re-configuring an existing one. A simple prototype, suitable for repeatability for manufacturing, would be the greatest developmental expense. In distributing the watch, the primary costs are producing the watches, shipping them to third world countries, and developing a support network for those distributing them in the field.

The business organization for Time-for-Life would serve dual bottom lines; that of making profit to continue development of humanitarian-oriented products and serving people worldwide with them. An economical and universal treatment scheduler has many additional markets besides the humanitarian cause for which it is focused: the elderly individual who must take an increasingly complicated regime of pills; a mentally disabled individual who can gain an additional measure of self-sufficiency through additional responsibility. What is ideal about the design of the TFL watch is that it is universal both in its operation but in its manufacture. One model can be produced to cater to any market.

The chief goal of Time-for-Life is the humanitarian relief of those who are infected with HIV/AIDS in third world countries. However, the costs of development, distribution, and marketing could be paid for by sales within profitable markets in the US and abroad. In addition, besides financial support from philanthropic donors, the continual supply of watches free of charge to patients in the third world could be supported by a “buy one, give one” campaign. As has been proven by the successful company TOMS, which sells simple canvas shoes on the basis that a pair purchased is a pair given for free to an improvised third world individual who cannot afford shoes, the TFL company would factor into retail price the costs of providing a Time-for-Life watch to someone in need. Furthermore, because the TFL watch could be programmed as a traditional digital, multi-function watch, it could be sold as a charity campaign in developed countries to those wishing to support humanitarian relief world-wide.

Once produced, Time-for-Life watches, depending on the marketing strategy, would be marketed to developed countries and to humanitarian organizations worldwide. Distribution would ideally occur directly through regional medical centers, bypassing complications and assuring that watches get directly to those that need them.

It is important to note that Time-for-Life would coordinate with but not manage the procurement or distribution of medicine. It is assumed that medicine would be provided either through direct donations from pharmaceutical companies are through philanthropic purchase and, through those independent channels, be distributed to medical centers in the field. Time-for-Life watches and pill packages would then function as a resource for making that medicine effective for those in need.

There are several issues related to treating patients in third world countries chief among them being political corruption, the stigma of HIV/AIDS, and the regulation of patients being treated.

Political corruption, though a challenge for HIV/AIDS relief as a whole, is not seen as particularly dangerous to the distribution of TFL watches. As opposed to monetary or food relief, TFL watches would have no foreseeable value for corrupt organizations wishing to gain power through controlling their supply. Furthermore, issues such as these are averted when watches are distributed directly through approved medical centers who often times have already reliable sources for transportation, communication, etc.

The stigma of HIV/AIDS is still highly present in third world countries where those known to be infected are treated essentially as outcasts. Wearing a TFL watch, of any design, would outwardly display ones affliction. Therefore, the TFL watch is designed such that it can be worn on the wrist, on a lanyard around the neck, or hidden discreetly in a pocket.

Lastly, the black market sale of medicine by patients is a particular dangerous threat. Its consequences are threefold: patients remain sick, those that receive black market medicine do not take it correctly and strengthen the virus, and corrupt black-market organizations are provided revenue. As part of the support structure listed above, strategies would be developed for incentivizing patient compliance with treatment. Among the solutions is the use of “tracer pills” which, when taken consistently by the patient, produce a physical or chemical trace that can be tested for by doctors when the patient returns for additional medication. If the patient is not in compliance, the appropriate measures can be taken. Furthermore, if they are taking their medication, they can be rewarded for doing so.

One of the greatest benefits of the Time-for-Life idea is that its impact potential is enormous while its cost and time-to-market is low. There are 6.7 million people that are in immediate need of life-saving treatment and Time-for-Life, with minimal investment and time, could provide relief for many of them. The technology exists and its development is not costly. Watches could be produced for as little as $10 and distributed for free to those in third world countries from revenue generated by a profitable market in the US and abroad. With nearly 25 percent of the United States population alone being older than 65, a large market does exist for people that take complex treatments and could benefit from a useful device to help them medicate consistently and correctly. With nearly 22 million people infected with HIV/AIDS in third world countries alone, there is a staggering number of people that need solutions to the challenges that keep them from effective treatment. Time-for-Life can benefit both of these markets. It is estimated that a manufacturability prototype can be produce for between $7.0 and $10.00 and that with as little as 50,000 units produced, target retail costs can be met. Furthermore, much of the infrastructure required for successful application of TFL watches in the field is already in place in the form of medical centers and relief clinics in operation by humanitarian organizations. A minimal support structure including trained individuals in the field, a community website, and channels of communication with experts, humanitarian organizations, and distribution sources is all that would be needed to continue support for TFL watches in use.

Time-for-Life is an idea that will remove one more barrier in the fight against HIV/AIDS. It allows for those in need, regardless of age, education, or nationality to have access to effective treatments that will lengthen and improve their quality of their life. The Time-for-Life company would be one that provides humanitarian relief through sustainable and profitable sales of a useful product. An organization that, once initiated, can grow to solve more problems and help as many people as possible both through their own efforts, but by allowing consumers, through their choice to purchases products that fund humanitarian efforts, to help as well. Thank you for reading.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What I claim as my invention is:

1. A method for assisting patients in taking medications, comprising the actions of:
a. labeling at least one medication with a predefined symbol; and
b. displaying the predefined symbol on any form of display, at a predetermined time when a patient is to take at least one medication.
